(19) United States
(12) Patent Application Publication
(10) Pub. No.: US 2011/0011080 A1
(43) Pub. Date: Jan. 20, 2011

(54) REFRIGERATION CYCLE APPARATUS

(75) Inventors: Takeshi Ogata, Osaka (JP); Hiroshi Hasegawa, Osaka (JP); Yu Shiotani, Osaka (JP); Yuichi Yakumaru, Osaka (JP); Masaru Matsui, Kyoto (JP)

Correspondence Address: HAMRE, SCHUMANN, MUELLER & LARSON P.C., P.O. BOX 2902, MINNEAPOLIS, MN, 55402-0902, US

(73) Assignee: Panasonic Corporation, Kadoma-shi, Osaka (JP)

(21) Appl. No.: 12/677,452

(22) PCT Filed: Jun. 19, 2009
(86) PCT No.: PCT/JP2009/002810

§ 371 Date: Mar. 10, 2010

(30) Foreign Application Priority Data
Jul. 18, 2008 (JP) 2008-186735

(51) Int. Cl. F02G 1/04

(52) U.S. Cl. 60/524

(57) ABSTRACT

A refrigeration cycle apparatus includes a first compressor 1, which is an expander-compressor unit, and a second compressor 2. A first compression mechanism 11 of the first compressor 1 and a second compression mechanism 21 of the second compressor 2 are disposed in parallel with each other in a refrigerant circuit 30. The refrigeration cycle apparatus is provided with an injection passage 6. A controller 7 controls a first motor 12 of the first compressor 1 and a second motor 22 of the second compressor 2, and an opening of an injection valve 61. The controller 7 performs an optimizing operation for the opening of the injection valve. In the optimizing operation, the opening of the injection valve 61 is brought closer to a fully closed state or closer to a fully opened state while a pressure or a temperature of a discharged refrigerant guided to a radiator 4 through a first pipe 3a is kept approximately constant.

### TECHNICAL FIELD

The present invention relates to a refrigeration cycle apparatus used for water heaters, air conditioners, etc., having an expansion mechanism and compression mechanisms.

### BACKGROUND ART

In recent years, for the purpose of further enhancing the efficiencies of refrigeration cycle apparatuses, there have been proposed power recovery type refrigeration cycle apparatuses using an expansion mechanism instead of an expansion valve, in which the expansion mechanism recovers the pressure energy as power during a process in which a refrigerant is expanded, and thus the electric power required for driving the compression mechanism is reduced by the amount of the power recovered. Such refrigeration cycle apparatuses use an expander-compressor unit, in which a motor, a compression mechanism, and an expansion mechanism are coupled by a shaft.

Since the compression mechanism is coupled to the expansion mechanism by the shaft in the expander-compressor unit, and there may be a case where the displacement of the compression mechanism is insufficient, or the displacement of the expansion mechanism is insufficient, depending on the operational conditions. In order to ensure adequate recovery power so that the COP (Coefficient of Performance) of the refrigeration cycle apparatus is kept high even under operational conditions where the displacement of the compression mechanism is insufficient, there also have been proposed refrigeration cycle apparatuses using a secondary compressor in addition to the expander-compressor unit (see Patent Literature 1, for example).

FIG. 14 is a configuration diagram showing the refrigeration cycle apparatus described in Patent Literature 1. In this refrigeration cycle apparatus, a first compression mechanism 101 of an expander-compressor unit 100 serving as a first compressor is disposed in parallel with a second compression mechanism 111 of a second compressor 110 in a refrigerant circuit 140. Specifically, the first compression mechanism 101 and the second compression mechanism 111 are connected to a radiator 120 by a first pipe 141 and to an evaporator 130 by a fourth pipe 144. An expansion mechanism 103 of the expander-compressor unit 100 is connected to the radiator 120 by a second pipe 142 and to the evaporator 130 by a third pipe 143. In the refrigeration cycle apparatus of Patent Literature 1, in order to prevent an excess or shortage from occurring in the amount of the refrigerant flowing into the expansion mechanism 103, the rotation speed of a first motor 102 of the expander-compressor unit 100 and the rotation speed of a second motor 112 of the second compressor 110 can be determined, respectively, according to the outside air temperature, etc.

Furthermore, the refrigeration cycle apparatus of Patent Literature 1 has a bypass passage 160 bypassing the expansion mechanism 103, and an injection passage 150 for supplying additionally the refrigerant to the expansion mechanism 103 during the expansion process of the refrigerant. The bypass passage 160 and the injection passage 150 are provided with a bypass valve 161 and an injection valve 151 for controlling the flow rate, respectively. In the refrigeration cycle apparatus of Patent Literature 1, the bypass valve 161 is in a closed state and the injection valve 151 is in an opened state in winter. The opening of the injection valve 151 is determined according to the outside air temperature, etc. Thereby, it is possible to cope even with the case where the displacement of the expansion mechanism 103 is insufficient.

### CITATION LIST

### Patent Literature

PTL 1: JP 2007-132622 A

### SUMMARY OF INVENTION

### Technical Problem

In the refrigeration cycle apparatus with an injection passage, however, the refrigerant flowing through the injection passage is expanded to some extent at the injection valve unless the injection valve is in the fully opened state. This causes a problem in that a part of the expansion energy cannot be recovered.

FIG. 5 is a graph showing the results of an energy loss (hereinafter referred to as “an injection loss”) caused by a pressure drop occurring when the refrigerant passes through the injection valve in the refrigeration cycle apparatus having an injection passage, measured by experiment. In the graph shown in FIG. 5, the horizontal axis indicates an injection flow rate (a flow rate of the refrigerant flowing through the injection passage) and the vertical axis indicates the injection loss. As shown in FIG. 5, the injection loss decreases as the injection flow rate decreases, that is, as the opening of the injection valve decreases, or the injection loss decreases as the injection flow rate increases, that is, as the opening of the injection valve increases. The injection loss is minimum when the injection flow rate is zero (when the injection valve is fully closed) and when the injection flow rate is maximum (when the injection valve is fully opened). In contrast, the injection loss relatively is large when the injection valve throttles the injection flow rate to some extent.

As described above, the injection loss depends on the injection flow rate, that is, on the opening of the injection valve, and varies significantly according to it. Thus, it is preferable that the opening of the injection valve is determined so as to reduce the injection loss. However, Patent Literature 1 merely states that the method for determining the opening of the injection valve is defined according to the outside air temperature, etc.

The present invention has been accomplished in view of the foregoing. An object of the present invention is to suppress the injection loss in a refrigeration cycle apparatus having an expansion mechanism and compression mechanisms as well as an injection passage, by adjusting appropriately the opening of an injection valve.

### Solution to Problem

With reference to FIG. 5, it is understood that the occurrence of the injection loss can be prevented by bringing the opening of the injection valve into the fully closed state or the fully opened state. In the refrigeration cycle apparatus, however, it is most preferable to keep the high pressure of the refrigeration cycle at an optimal high pressure, and merely bringing the opening of the injection valve into the fully closed state or the fully opened state may cause the high pressure of the refrigeration cycle to deviate significantly from the optimal high pressure. Hence, the inventors of the present invention thought that there was a desirable opening that can reduce the injection loss while keeping the high pressure of the refrigeration cycle at the optimal high pressure.

The present invention has been accomplished in view of the foregoing. The present invention provides a refrigeration cycle apparatus comprising:

a first compressor including a first compression mechanism for compressing a refrigerant, an expansion mechanism for recovering power from the refrigerant expanding, a first motor coupled to the first compression mechanism and the expansion mechanism by a shaft, and a first closed casing accommodating the first compression mechanism, the expansion mechanism and the first motor;

a second compressor including a second compression mechanism for compressing the refrigerant connected in parallel with the first compression mechanism in a refrigerant circuit, a second motor coupled to the second compression mechanism by a shaft, and a second closed casing accommodating the second compression mechanism and the second motor;

a radiator for radiating heat from the refrigerant discharged from the first compression mechanism and the second compression mechanism;

a first pipe connecting the first compression mechanism and the second compression mechanism to the radiator;

a second pipe connecting the radiator to the expansion mechanism;

an injection passage, branched from the second pipe, for supplying additionally the refrigerant to the expansion mechanism during an expansion process;

an opening-adjustable injection valve provided in the injection passage; and

a controller for performing an optimizing operation for the opening of the injection valve by controlling rotation speeds of the first motor and the second motor as well as the opening of the injection valve so as to bring the opening of the injection valve closer to a fully closed state or closer to a fully opened state while keeping a pressure or a temperature of the discharged refrigerant guided to the radiator through the first pipe approximately constant.

### Advantageous Effects of Invention

The refrigeration cycle apparatus of the present invention configured as mentioned above makes it possible to suppress the injection loss while keeping the high pressure of the refrigeration cycle at an optimal high pressure.

### BRIEF DESCRIPTION OF DRAWINGS

FIG. 1 is a schematic configuration diagram of a refrigeration cycle apparatus according to Embodiment 1 of the present invention.

FIG. 2 is an example of an operation pattern of the refrigeration cycle apparatus according to Embodiment 1 of the present invention.

FIG. 3 is an example of an operation pattern of the refrigeration cycle apparatus according to Embodiment 1 of the present invention.

FIG. 4 is an example of an operation pattern of the refrigeration cycle apparatus according to Embodiment 1 of the present invention.

FIG. 5 is a diagram showing a relationship between an injection flow rate and an injection loss.

FIG. 6 is a flow chart illustrating a control executed in Embodiment 1 of the present invention.

FIGS. 7A and 7B are flow charts illustrating controls executed in Embodiment 1 of the present invention.

FIG. 8 is a schematic configuration diagram of a refrigeration cycle apparatus according to Embodiment 2 of the present invention.

FIG. 9 is a flow chart illustrating a control executed in Embodiment 2 of the present invention.

FIG. 10 is a flow chart for a modified example of Embodiment 2.

FIG. 11 is a schematic configuration diagram of a refrigeration cycle apparatus according to Embodiment 3 of the present invention.

FIG. 12 is a flow chart illustrating a control executed in Embodiment 3 of the present invention.

FIG. 13A is a diagram showing relationships between an injection flow rate and an injection loss and between an injection flow rate and a pressure. FIG. 13B is a Mollier diagram for describing a saturated injection pressure.

FIG. 14 is a schematic configuration diagram of a conventional heat pump apparatus.

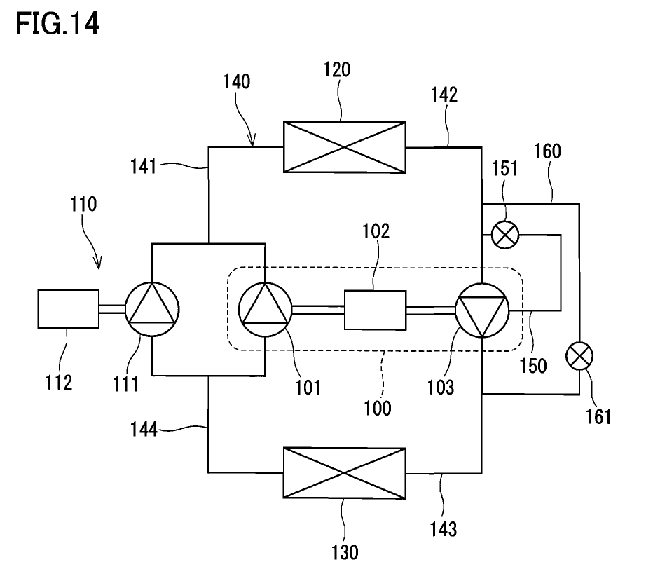

### DESCRIPTION OF EMBODIMENTS

Hereinafter, embodiments of the present invention will be described with reference to the drawings.

### Embodiment 1

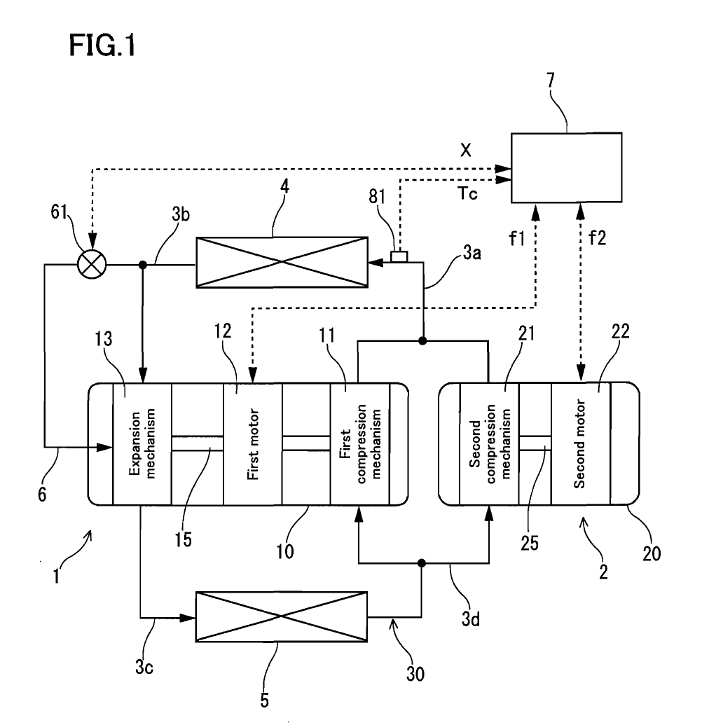

FIG. 1 shows a refrigeration cycle apparatus according to Embodiment 1 of the present invention. The refrigeration cycle apparatus includes a refrigerant circuit 30. The refrigerant circuit 30 is composed of a first compressor (expander-compressor unit) 1, a second compressor 2, a radiator 4, an evaporator 5, and first to fourth pipes (refrigerant pipes) 3a to 3d connecting these components.

The first compressor 1 has a first closed casing 10 accommodating a first compression mechanism 11, a first motor 12, and an expansion mechanism 13 connected to each other by a first shaft 15. A second compressor 2 has a second closed casing 20 accommodating a second compression mechanism 21 and a second motor 22 connected to each other by a second shaft 25. The first compression mechanism 11 and the second compression mechanism 21 are connected to the radiator 4 via the first pipe 3a in which two branch pipes are merged into one main pipe. The radiator 4 is connected to the expansion mechanism 13 via the second pipe 3b. The expansion mechanism 13 is connected to the evaporator 5 via the third pipe 3c. The evaporator 5 is connected to the first compression mechanism 11 and the second compression mechanism 21 via the fourth pipe 3d in which one main pipe is branched into two branch pipes. More specifically, the first compression mechanism 11 and the second compression mechanism 21 are disposed in parallel with each other in the refrigerant circuit 30. In other words, the first compression mechanism 11 is connected in parallel with the second compression mechanism 21 in the refrigerant circuit 30.

The refrigerant compressed by the first compression mechanism 11 and that compressed by the second compression mechanism 21 are discharged into the first pipe 3a from the first compression mechanism 11 and the second compression mechanism 21, and then merged with each other while flowing through the first pipe 3a so as to be guided to the radiator 4. The refrigerants compressed by the compression mechanisms 11 and 21 may be discharged from the compression mechanisms 11 and 21 once into the closed casing 10 and 20, and then discharged from the closed casings 10 and 20 into the first pipe 3a. The refrigerant guided to the radiator 4 radiates heat there, and then is guided to the expansion mechanism 13 through the second pipe 3b. The refrigerant guided to the expansion mechanism 13 expands there. At this time, the expansion mechanism 13 recovers power from the expanding refrigerant. The expanded refrigerant is guided to the evaporator 5 through the third pipe 3c. The refrigerant guided to the evaporator 5 absorbs heat there, and then is divided while flowing through the fourth pipe 3d so as to be guided to the first compression mechanism 11 and the second compression mechanism 21.

The refrigeration cycle apparatus further includes an injection passage 6, branched from the second pipe 3b, for supplying additionally the refrigerant to the expansion mechanism 13 during the expansion process of the refrigerant. An opening adjustable injection valve 61 for controlling flow rate is provided in the injection passage 6.

The refrigeration cycle apparatus also includes a controller 7 that controls mainly the rotation speeds of the first motor 12 and the second motor 22, and the opening of the injection valve 61.

This refrigerant circuit 30 is filled with the refrigerant that reaches a supercritical state in a high-pressure portion (a portion from the first compression mechanism 11 and the second compression mechanism 21 to the expansion mechanism 13 through the radiator 4). In the present embodiment, the refrigerant circuit 30 is filled with carbon dioxide (CO₂) serving as the refrigerant. It should be noted, however, that the type of the refrigerant is not particularly limited, and it may be a refrigerant (such as a fluorocarbon refrigerant) that does not reach the supercritical state during operation.

The refrigerant circuit included in the refrigeration cycle apparatus of the present invention is not limited to the refrigerant circuit 30 that allows the refrigerant to circulate only in one direction. It may be a refrigerant circuit in which the flowing direction of the refrigerant can be changed, for example, a refrigerant circuit having four-way valves, etc. so as to switch between a heating operation and a cooling operation.

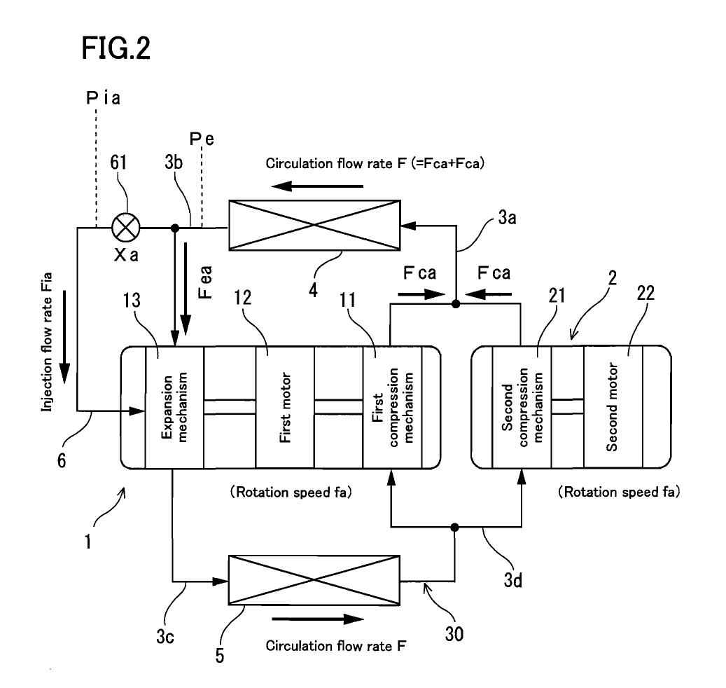

Next, operation patterns of the refrigeration cycle apparatus of the present embodiment will be described using FIG. 2 to FIG. 4.

FIG. 2 shows an operation pattern adopted when the first motor 12 and the second motor 22 rotate at the same rotation speed fa. The second compression mechanism 21 has the same displacement volume as that of the first compression mechanism 11. The discharge flow rate of the refrigerant discharged from the first compression mechanism 11 and the discharge flow rate of the refrigerant discharged from the second compression mechanism 21 each are denoted as Fca, and the circulation flow rate of the refrigerant circulating through the refrigerant circuit 30 is denoted as F (=Fca+Fca). The opening of the injection valve 61 at this time is denoted as Xa. An injection flow rate is denoted as Fia, a main flow rate of the refrigerant guided from the second pipe 3b to the expansion mechanism 13 is denoted as Fea, a valve downstream pressure on a downstream side of the injection valve 61 in the injection passage 6 is denoted as Pia, and a pressure of the refrigerant flowing through the second pipe 3b is denoted as Pe. This state is defined as a reference operational state under a certain outside air temperature condition.

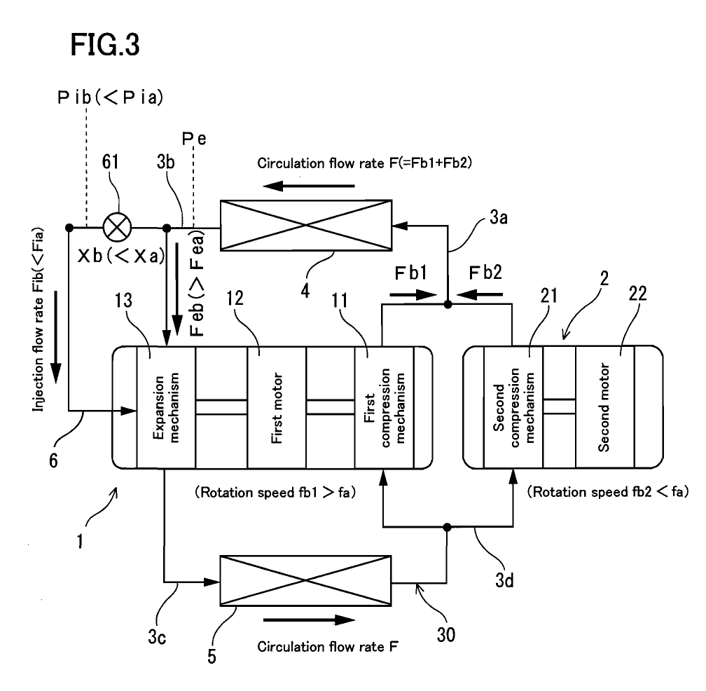

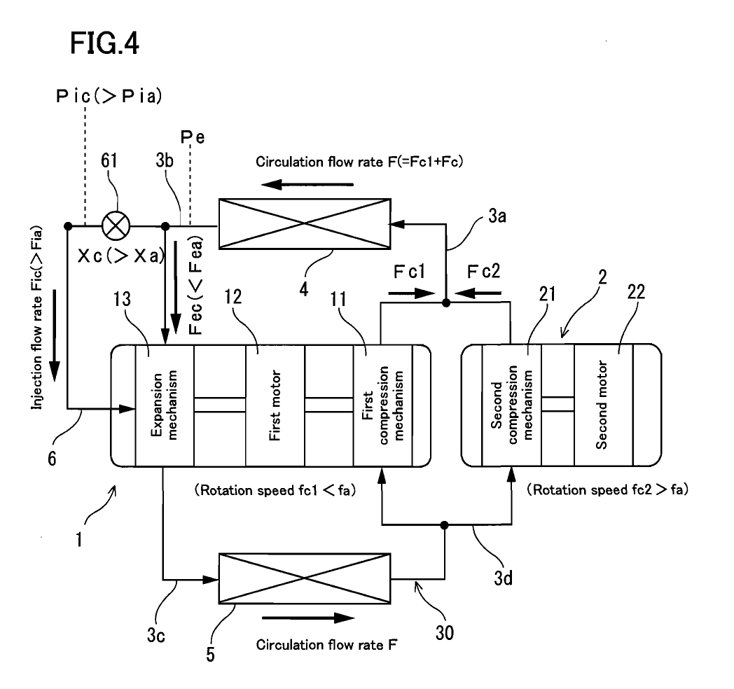

FIG. 3 and FIG. 4 show operation patterns adopted when the rotation speeds of the first motor 12 and the second motor 22, and the opening of the injection valve 61 are changed so that the high pressure and low pressure of the refrigeration cycle, and the temperature and circulation flow rate of the refrigerant are kept the same as those in FIG. 2 under the same outside air temperature condition as in FIG. 2.

In the case of FIG. 3, rotation speed fb1 of the first motor 12 is higher than fa, and rotation speed fb2 of the second motor 22 is lower than fa. Since the rotation speed of the expansion mechanism 13 also increases when the rotation speed of the first motor 12 increases, flow rate Feb of the refrigerant flowing from the second pipe 3b into the expansion mechanism 13 increases. Therefore, reducing the injection flow rate makes it possible to equalize the circulation flow rate F of the refrigerant passing through the expansion mechanism 13 with that in the operation pattern shown in FIG. 2. Since the injection flow rate is suppressed, opening Xb of the injection valve at this time is lower than Xa, and thus the valve downstream pressure Pib also is lower than Pia. More specifically, the refrigerant is injected at a low injection flow rate while the pressure is reduced significantly at the injection valve 61.

Contrary to FIG. 3, rotation speed fc1 of the first motor 12 is lower than fa, and rotation speed fc2 of the second motor 22 is higher than fa in FIG. 4. That is, since the rotation speed of the expansion mechanism 13 also decreases when the rotation speed of the first motor 12 decreases, flow rate Fec of the refrigerant flowing from the second pipe 3b into the expansion mechanism 13 decreases. Therefore, increasing the injection flow rate makes it possible to equalize the circulation flow rate F of the refrigerant passing through the expansion mechanism 13 with that in the operation pattern shown in FIG. 2. Since the injection flow rate is increased, the opening Xc of the injection valve at this time is higher than Xa, and thus the valve downstream pressure Pic also is higher than Pia. More specifically, the refrigerant is injected at a high injection flow rate with less pressure reduction at the injection valve 61.

Although the apparent states of the refrigeration cycle apparatus are the same in all of the operation patterns shown in FIGS. 2, 3 and 4 as described above, the injection flow rates are different, which results in a variation in the energy loss caused when the injection valve 61 reduces the pressure.

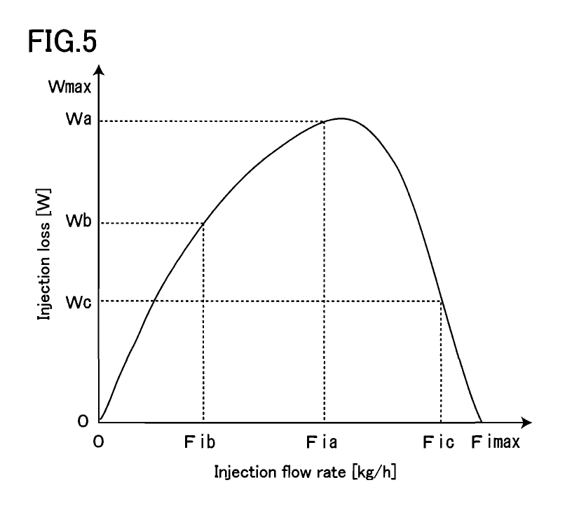

FIG. 5 is a graph showing a relationship between the injection flow rate and the injection loss measured by experiment, as described in the Technical Problem section. When the injection flow rate is 0, that is, when the opening of the injection valve 61 is in the fully closed state, the injection loss is also 0 because no refrigerant is flowing in the injection passage 6. In contrast, when the opening of the injection valve 61 is in the fully opened state so that the injection flow rate is maximum, no injection loss is generated either because the pressure is not reduced at the injection valve 61. More specifically, the injection loss is characterized in that it is caused when the pressure is reduced at the injection valve 61, and becomes maximum when the level of the pressure reduction is moderate and the injection flow rate of the refrigerant flowing through the injection passage 6 also is moderate. If the injection loss can be suppressed, it is possible to achieve high energy recovery efficiency over a wide operational range even when the outside air temperature varies. In order to realize this, it is preferable to control optimally the rotation speeds of the first motor 12 and the second motor 22, and the opening of the injection valve 61 so that the injection flow rate is minimum or maximum. It should be noted, however, that this control needs to be performed while keeping the high pressure of the refrigeration cycle at the optimal high pressure.

Next, the control performed by the controller 7 will be described. The controller 7 performs a starting operation first, and then performs an optimizing operation for the opening of the injection valve (hereinafter simply referred to as “optimizing operation”) as mentioned above.

First, the starting operation will be described. The controller 7 brings the refrigeration cycle apparatus from a stopped state into a particular steady state. The particular steady state means a state in which the high pressure of the refrigeration cycle is approximately equal to an optimal high pressure (a pressure at which the COP is highest) corresponding to the outside air temperature at that time. In the present embodiment, as shown in FIG. 1, the controller 7 detects the temperature Tc of the discharged refrigerant guided to the radiator 4 through the first pipe 3a by using a temperature sensor 81 provided at the main pipe portion of the first pipe 3a, and executes control so that the temperature Tc reaches a target value (the temperature that allows the high pressure of the refrigeration cycle to be equal to the optimal high pressure). The controller 7 stores the target value beforehand corresponding to the outside air temperature.

For example, the controller 7 increases, upon starting, the rotation speeds of the first motor 12 and the second motor 22 to the same rotation speed corresponding to the outside air temperature, and then adjusts opening X of the injection valve 61 so that the temperature Tc of the discharged refrigerant meets the target value. Thereby, the starting operation is performed. Performing the starting operation in this way broadens the range for rotation speed adjustment in the optimizing operation to be performed later because the rotation speeds of the first motor 12 and the second motor 22 become the same as each other. Therefore, application to wider operational ranges is possible.

Alternatively, the controller 7 increases, upon starting, the rotation speeds of the first motor 11 and the second motor 12 to different rotation speeds from each other corresponding to the outside air temperature, and then adjusts the opening X of the injection valve 61 so that the temperature Tc of the discharged refrigerant meets the target value. Thereby, the starting operation is performed. Performing the starting operation in this way makes it possible to suppress the amount of oil discharged from the first compressor 1 by allowing the rotation speed of the first compressor 1 having two rotating mechanisms, such as the first compression mechanism 11 and the expansion mechanism 13, to be lower than the rotation speed of the second compressor 2. More specifically, an oil for lubricating the rotating mechanisms is held in the first closed casing 10 and the second closed casing 20, and the oil is discharged out of the closed casings together with the refrigerant. Generally, a larger amount of oil is discharged out of the closed casing in the first compressor 1 having the plurality of rotating mechanisms than in the second compressor 2. Also, the total amount of the oils discharged from the first compressor 1 and the second compressor 2 decreases when the rotation speed of the first compressor 1 decreases. Thereby, a sufficient oil reservoir also is kept in the first compressor 1, enhancing the reliability of the apparatus.

In the refrigeration cycle apparatus of the present embodiment, the opening X of the injection valve 61 may be in the fully closed state at the time of starting. This makes it possible to generate promptly a difference between the low pressure and the high pressure in the refrigeration cycle upon starting, and shorten the transition time to the steady operation.

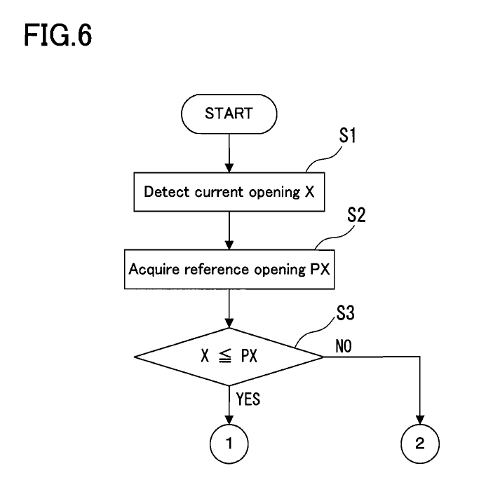

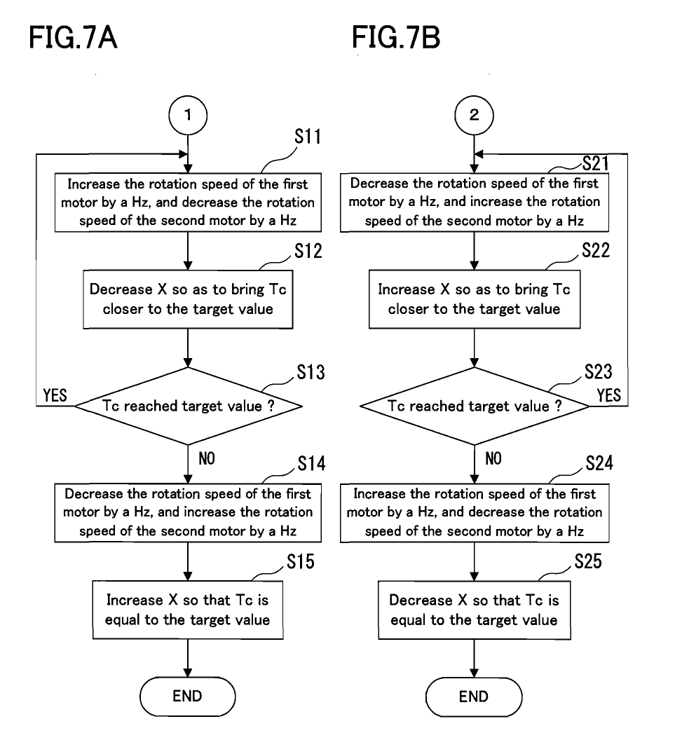

Next, the optimizing operation performed by the controller 7 will be described. FIG. 6 and FIG. 7 show flow charts of the optimizing operation. In the optimizing operation, the controller 7 brings the opening X of the injection valve 61 closer to the fully closed state or fully opened state while keeping the temperature Tc of the discharged refrigerant approximately constant. Specifically, when performing the optimizing operation, the controller 7 decides whether the opening X of the injection valve 61 should be brought closer to the fully closed state or to the fully opened state. If the controller 7 decides that the opening X should be brought closer to the fully closed state, the controller 7 decreases the opening X of the injection valve 61 while increasing rotation speed f1 of the first motor 12 and decreasing rotation speed f2 of the second motor 22. If the controller 7 decides that the opening X should be brought closer to the fully opened state, the controller 7 increases the opening X of the injection valve 61 while decreasing the rotation speed f1 of the first motor 12 and increasing the rotation speed f2 of the second motor 22.

More specifically, as shown in FIG. 6, the controller 7 detects the current opening X of the injection valve 61 (Step S1) first, and then acquires predetermined reference opening PX (Step S2). As the reference opening PX, an opening that maximizes the injection loss preferably is used. The reference opening PX can be determined at each given outside air temperature by experiment or simulation. In this case, the reference openings PX are stored in a storage part of the controller 7 in advance as values corresponding to the outside air temperatures, and the controller 7 reads one reference opening PX corresponding to the outside air temperature at that time out of the storage part. Alternatively, a fixed or selective arbitrary opening (50%, for example) may be used as the reference opening PX.

The controller 7 compares the current opening X with the reference opening PX (Step S3), and if the current opening X is lower than the reference opening PX (YES in Step S3), the controller 7 decides that the opening X should be brought closer to the fully closed state and proceeds to Step S11 shown in FIG. 7A. In contrast, if the current opening X is higher than the reference opening PX (NO in Step S3), the controller 7 decides that the opening X should be brought closer to the fully opened state and proceeds to Step S21 shown in FIG. 7B. Although the controller 7 proceeds to Step S11 when X=PX in the present embodiment, it may proceed to Step S21 or end the optimizing operation.

Thereafter, the controller 7 repeats an adjustment process until the temperature Tc of the discharged refrigerant fails to reach a target value. In the adjustment process, the rotation speed f1 of the first motor 12 and the rotation speed f2 of the second motor 22 each are changed only by a specified amount and then the opening X of the injection valve 61 is changed so as to bring the temperature Tc of the discharged refrigerant closer to the target value. When the temperature Tc of the discharged refrigerant fails to reach the target value, the controller 7 returns the rotation speed f1 of the first motor 12 and the rotation speed f2 of the second motor as well as the opening X of the injection valve 61 to a condition one time earlier. Thereby, the optimizing operation is ended.

Specifically, if the controller 7 decides that the opening X should be brought closer to the fully closed state, it increases the rotation speed f1 of the first motor 12 by a Hz and decreases the rotation speed f2 of the second motor 22 by a Hz (Step S11). Subsequently, in order to reduce the injection flow rate by the amount of the increase in the rotation speed f1 of the first motor 11, the controller 7 decreases the opening X of the injection valve 61 and brings the temperature Tc of the discharged refrigerant closer to the target value (Step S12). This step is carried out by, for example, decreasing the opening X of the injection valve 61 step by step and checking whether the temperature Tc of the discharged refrigerant has reached the target value at each time. As a result, if the temperature Tc of the discharged refrigerant has reached the target value (YES in Step S13), there still is a possibility for the opening X to be decreased. Thus, the adjustment process (Steps S11 and S12) is performed once again. This adjustment process is repeated, and if the temperature Tc of the discharged refrigerant fails to reach the target value when or before the opening X of the injection valve 61 is brought into the fully closed state (0%) (NO in Step S13), the controller 7 decreases the rotation speed f1 of the first motor 12 by a Hz and increases the rotation speed f2 of the second motor 22 by a Hz (Step S14), readjusts the temperature Tc of the discharged refrigerant to the target value (Step S15), and ends the control.

In contrast, if the controller 7 decides that the opening X should be brought closer to the fully opened state, it executes a control opposite to the above-mentioned one. More specifically, the controller 7 decreases the rotation speed f1 of the first motor 12 by a Hz and increases the rotation speed f2 of the second motor 22 by a Hz (Step S21). Subsequently, in order to increase the injection flow rate by the amount of the decrease in the rotation speed f1 of the first motor 11, the controller 7 increases the opening X of the injection valve 61 and brings the temperature Tc of the discharged refrigerant closer to the target value (Step S22). This step is carried out by, for example, increasing the opening X of the injection valve 61 little by little and checking whether the temperature Tc of the discharged refrigerant has reached the target value at each time. As a result, if the temperature Tc of the discharged refrigerant has reached the target value (YES in Step S23), there still is a possibility for the opening X to be increased. Thus, the adjustment process (Steps S21 and S22) is performed once again. This adjustment process is repeated, and if the temperature Tc of the discharged refrigerant fails to reach the target value when or before the opening X of the injection valve 61 is brought into the fully opened state (100%) (NO in Step S23), the controller 7 increases the rotation speed f1 of the first motor 12 by a Hz and decreases the rotation speed f2 of the second motor 22 by a Hz (Step S24), readjusts the temperature Tc of the discharged refrigerant to the target value (Step S25), and ends the control.

Here, it is desirable that the increment/decrement of a Hz by which the rotation speeds of the first motor 12 and the second motor 22 are changed during one adjustment process in the optimizing operation be the minimum increment/decrement that the controller 7 can handle. It may be a larger increment/decrement than this (approximately 5 Hz, for example).

Such an optimizing operation makes it possible to suppress the injection loss while keeping the high pressure of the refrigeration cycle at the optimal high pressure. Thereby, highly effective power recovery can be realized.

Here, it can be considered to decrease the opening X of the injection valve 61 first, and then change the rotation speed f1 of the first motor 12 and the rotation speed f2 of the second motor so that the temperature Tc of the discharged refrigerant reaches the target value. In this case, however, there is a possibility that the temperature Tc of the discharged refrigerant cannot reach the target value because the minimum increment/decrement in adjusting the rotation speed usually is not so small. In contrast, in the case where the rotation speed f1 of the first motor 12 and the rotation speed f2 of the second motor are changed and thereafter the opening X of the injection valve 61 is adjusted as in the present embodiment, it is easier to adjust the temperature Tc of the discharged refrigerant to the target value because the minimum increment/decrement in adjusting the valve opening usually is extremely small.

### Embodiment 2

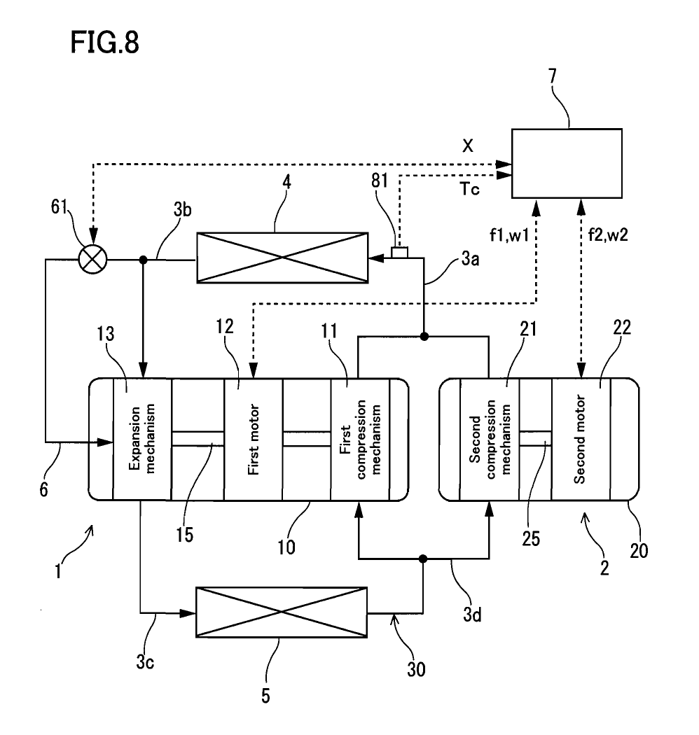

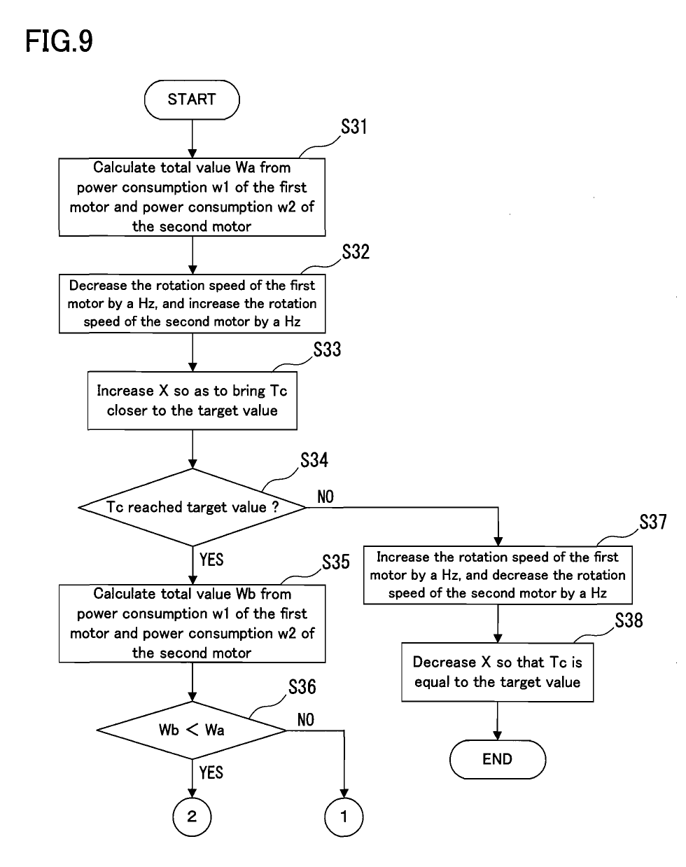

FIG. 8 shows a refrigeration cycle apparatus according to Embodiment 2 of the present invention. FIG. 9 shows a flow chart illustrating the first half of the optimizing operation in Embodiment 2. Since Embodiment 2 is different from Embodiment 1 only in the criteria for deciding whether the opening X of the injection valve 61 should be brought closer to the fully closed state or closer to the fully opened state, only this point will be described below.

When performing the optimizing operation after the starting operation, the controller 7 measures firstly power consumption w1 of the first motor 12 and power consumption w2 of the second motor 22 and calculates the total value Wa (=w1+w2) (Step S31). Subsequently, the controller 7 decreases the rotation speed f1 of the first motor 12 by a Hz and increases the rotation speed f2 of the second motor 12 by a Hz (Step S32). Thereafter, in order to increase the injection flow rate by the amount of the decrease in the rotation speed f1 of the first motor 12, the controller 7 increases the opening X of the injection valve 61 and brings the temperature Tc of the discharged refrigerant closer to the target value (Step S33). These Step S32 and Step S33 are performed in the same manner as Step S21 and Step S22 that are shown in FIG. 7B and described in Embodiment 1. At this time, if the temperature Tc of the discharged refrigerant fails to reach the target value (NO in Step S34), the controller 7 returns the rotation speed f1 of the first motor 12 and the rotation speed f2 of the second motor 22 as well as the opening X of the injection valve 61 to the original values (Step S37 and Step S38), and ends the optimizing operation.

When the temperature Tc of the discharged refrigerant reaches the target value (YES in Step S34) as a result of Step S33, the controller 7 measures the power consumption w1 of the first motor 11 and the power consumption w2 of the second motor 12 once again and calculates total value Wb (=w1+w2) (Step S35). Thereafter, the controller 7 compares the total value Wb with the total value Wa calculated previously (Step S36), and judges whether the total value of the power consumption w1 of the first motor 11 and the power consumption w2 of the second motor 12 has been decreased or increased from that calculated before Step S32 and Step S33 were performed.

When Wb is smaller than Wa, that is, if the total value of the power consumptions has been decreased (YES in Step S36), the controller 7 decides that the opening X of the injection valve 61 should be brought closer to the fully opened state and proceeds to Step S21 shown in FIG. 7B. If Wb is larger than Wa, that is, if the total value of the power consumptions has been increased (NO in Step S36), the controller 7 decides that the opening X of the injection valve 61 should be brought closer to the fully closed state and proceeds to Step S11 shown in FIG. 7A. After that, the same control is performed as in Embodiment 1. Although the controller 7 proceeds to Step S11 when Wb=Wa in the present embodiment, it may proceed to Step S21 or end the optimizing operation when Wb=Wa.

With the above-mentioned configuration, the controller 7 can execute control while judging the total value of inputs to the first motor 12 and the second motor 22. Thus, the operation pattern can be shifted in such a manner that the COP of the refrigeration cycle apparatus certainly is enhanced. In addition, the temperature sensor 81 as described in Embodiment 1 is not necessary, and the configuration of the apparatus also can be simplified.

Although the power consumption w1 of the first motor 12 and the power consumption w2 of the second motor 22 are measured directly in the present embodiment, values of currents flowing through the motors 12 and 22 may be measured instead of the power consumptions. Generally, the power consumptions of the motors can be estimated from the values of the currents. Thus, the controller 7 can be configured simply at low cost by using the value of the current that is easier to measure.

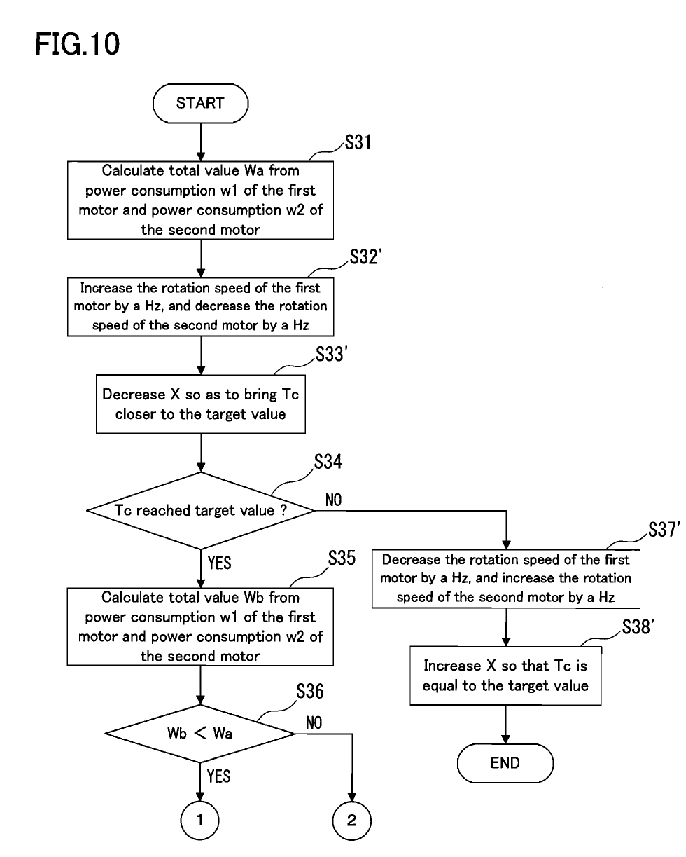

Moreover, in the present embodiment, the control operates to increase the opening X of the injection valve 61 once in order to decide whether the opening X of the injection valve 61 should be brought closer to the fully closed state or closer to the fully opened state. However, the control may be opposite. More specifically, as shown in FIG. 10, after Step S31 is performed, the rotation speed f1 of the first motor 12 is increased and the rotation speed of the second motor 22 is decreased (Step S32′), and then the opening X of the injection valve 61 is decreased to bring the temperature Tc of the discharged refrigerant closer to the target value (Step S33′). As a result, if the temperature Tc of the discharged refrigerant fails to reach the target value (NO in Step S34), the controller 7 returns the rotation speed f1 of the first motor 12 and the rotation speed f2 of the second motor as well as the opening X of the injection valve 61 to the original values (Step S37′ and Step S38′), and ends the optimizing operation.

In contrast, if YES in Step S34, the controller 7 proceeds to Step S35 as in the flow chart shown in FIG. 9, and judges whether the total value of the power consumption w1 of the first motor 12 and the power consumption w2 of the second motor 22 has decreased or increased from that calculated before Step S32′ and Step S33′ were performed (Step S36). It should be noted, however, that in the flow chart shown in FIG. 10, the controller 7 makes opposite decisions to those in the flow chart shown in FIG. 9. More specifically, if Wb is smaller than Wa, that is, if the total value of the power consumptions has been decreased (YES in Step S36), the controller 7 decides that the opening X of the injection valve 61 should be brought closer to the fully closed state and proceeds to Step S11 shown in FIG. 7A, and if Wb is larger than Wa, that is, if the total value of the power consumptions has been increased (NO in Step S36), the controller 7 decides that the opening X of the injection valve 61 should be brought closer to the fully opened state and proceeds to Step S21 shown in FIG. 7B.

### Embodiment 3

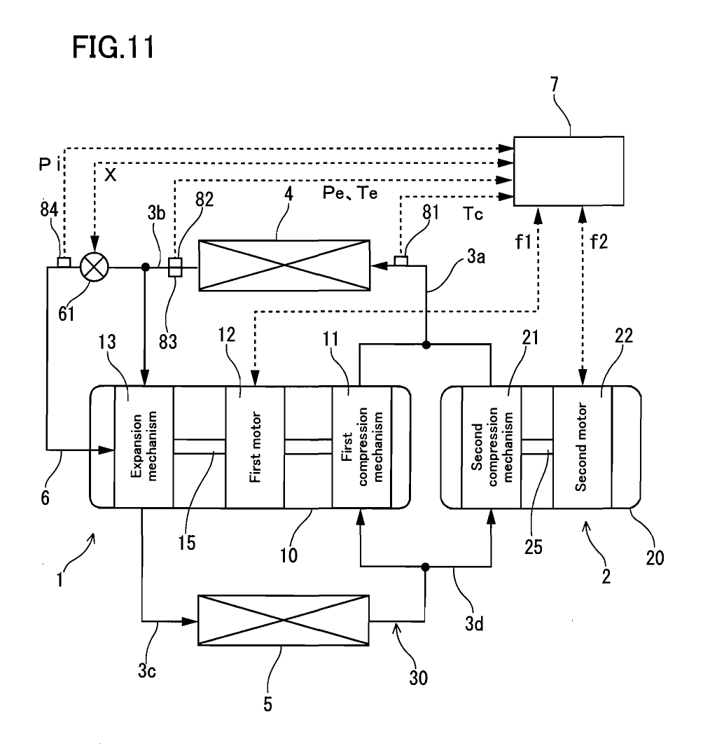

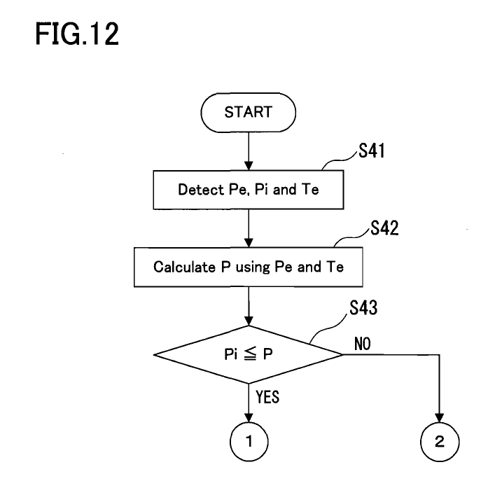

FIG. 11 shows a refrigeration cycle apparatus according to Embodiment 3 of the present invention. FIG. 12 shows a flow chart illustrating the first half of the optimizing operation in Embodiment 3. Like Embodiment 2, Embodiment 3 is different from Embodiment 1 only in the criteria for deciding whether the opening X of the injection valve 61 should be brought closer to the fully closed state or closer to the fully opened state, and thus only this point will be described below.

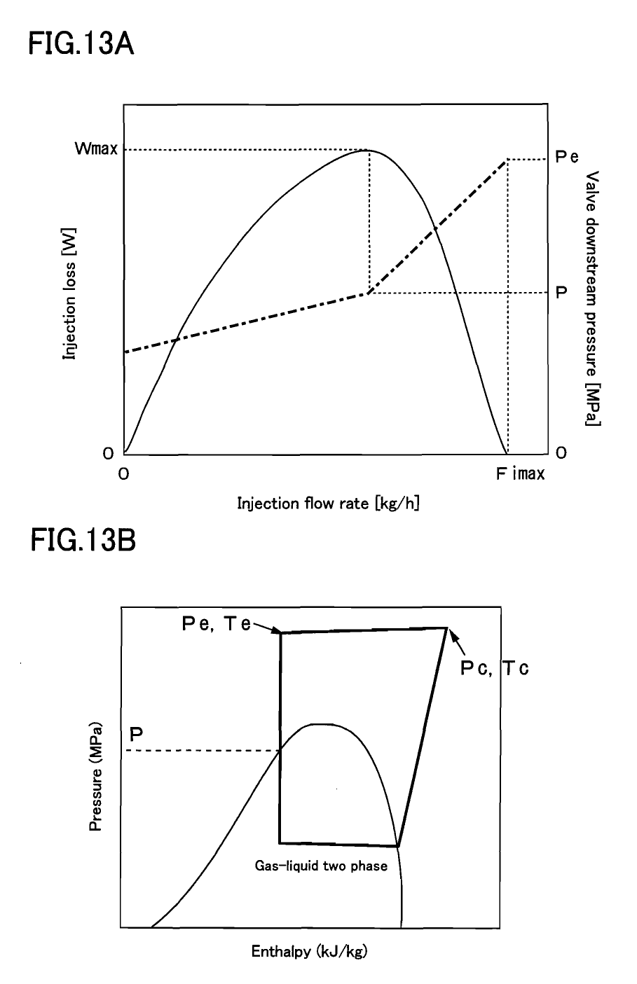

When performing the optimizing operation after the starting operation, the controller 7 detects firstly pressure Pe and temperature Te of the refrigerant flowing through the second pipe 3b by using a pressure sensor 82 and a temperature sensor 83 provided at the second pipe 3b, and detects valve downstream pressure Pi by using a pressure sensor 84 provided at the injection passage 6 (Step S41). Subsequently, the controller 7 calculates saturated injection pressure P using the pressure Pe and the temperature Te (Step S42). Here, the saturated injection pressure P is described using FIG. 13B. Before passing through the injection valve 61, the refrigerant flowing through the injection passage 6 has the same pressure and the same temperature as those of the refrigerant guided from the second pipe to the expansion mechanism 5, and its flow rate is adjusted while being subject to isenthalpic pressure reduction when passing through the injection valve 61. That is, as illustrated by the Mollier diagram of the refrigeration cycle apparatus, the refrigerant flowing through the injection passage 6 is decompressed from the Pe and Te while being isenthalpic, and the line intersects with the saturation curve. The pressure at the intersection is defined as the saturated injection pressure P. In other words, the controller 7 calculates the saturated injection pressure from the pressure Pe and the temperature Te as well as the saturation curve.

FIG. 13A shows relationships between an injection flow rate and an injection loss and between an injection flow rate and a pressure. The refrigerant flowing through the injection passage 6 is in a supercritical state when the refrigerant has a higher pressure than the saturated injection pressure P. Thus, a change in density is small with respect to a change in pressure. In contrast, when the refrigerant has a lower pressure than the saturated injection pressure P, the change in density is increased rapidly because the refrigerant is in a gas-liquid two phase state. Because of such a difference, the amount of change in the valve downstream pressure Pi with respect to the change in the injection flow rate differs between above and below the saturated injection pressure P. It was proved by experiment that the injection loss was almost maximum when the valve downstream pressure Pi was equal to the saturated injection pressure P.

Going back to FIG. 12, after the controller 7 calculates the saturated injection pressure P, the controller 7 compares the valve downstream pressure Pi with the saturated injection pressure P (Step S43). If the valve downstream pressure Pi is lower than the saturated injection pressure P (YES in Step S43), the controller 7 decides that the opening X of the injection valve 61 should be brought closer to the fully closed state and proceeds to Step S11 shown in FIG. 7A. In contrast, if the valve downstream pressure Pi is higher than the saturated injection pressure P (NO in Step S43), the controller 7 decides that the opening X of the injection valve 61 should be brought closer to the fully opened state and proceeds to Step S21 shown in FIG. 7B. After that, the same control as in Embodiment 1 is performed. Although the controller 7 proceeds to Step S11 when Pi=P in the present embodiment, it may proceed to Step S21 or end the optimizing operation when Pi=P.

With the above-mentioned configuration, a highly accurate control can be executed according to the decision made by using the valve downstream pressure Pi.

Even when the pressure sensor 82 and the temperature sensor 83 are located on an upstream side of the injection valve 61 in the injection passage 6, it is possible to detect the pressure Pe and temperature Te of the refrigerant flowing through the second pipe 3b by using these sensors 82 and 83.

### Modified Example

In the refrigeration cycle apparatus of each of the Embodiments, the temperature Tc of the discharged refrigerant is used when the controller 7 adjusts the opening X of the injection valve 61. However, the pressure of the discharged refrigerant may be used instead. This makes it possible to determine the opening X that maximizes the COP of the refrigeration cycle apparatus, based on the discharge pressures of the compression mechanisms 11 and 21.

Moreover, although the first compression mechanism 11 and the second compression mechanism 21 having the same displacement volume as each other are employed in the Embodiments, the first compression mechanism 11 and the second compression mechanism 21 may have different displacement volumes from each other. In this case, the first compression mechanism 11 and the second compression mechanism 21 may not use the same value of a Hz as the increment/decrement by which the rotation speeds of the first motor 11 and the second motor 21 are changed during one adjustment process in the optimizing operation as in each of the Embodiments, but may use different values from each other according to the ratio between the displacement volume of the first compression mechanism 11 and that of the second compression mechanism 21.

Moreover, in each of the Embodiments, the controller may end the optimizing operation when one of the rotation speeds of the first motor 12 and the second motor 22 is equal to a lower limit value or an upper limit value of an allowable driving range. With this configuration, it is possible to ensure the reliabilities of the first compressor 1 and the second compressor 2 and extend the lives of the devices.

Furthermore, in each of the Embodiments, the optimizing operation may be ended when the difference between the rotation speed of the first motor 12 and the rotation speed of the second motor 22 exceeds a certain threshold, or when the ratio of the rotation speed of the first motor 12 to the rotation speed of the second motor 22 exceeds a certain threshold. With this configuration, it is possible to prevent an extremely large difference from being generated between the rotation speeds, suppress the imbalance between the oil reservoirs held in bottom portions of the closed casings, ensure the reliabilities of the first compressor 1 and the second compressor 2, and extend the lives of the devices.

### INDUSTRIAL APPLICABILITY

The refrigeration cycle apparatus of the present invention is useful as a means for recovering expansion energy of a refrigerant in a refrigeration cycle so as to recover power.

1. A refrigeration cycle apparatus comprising:
a first compressor including a first compression mechanism for compressing a refrigerant, an expansion mechanism for recovering power from the refrigerant expanding, a first motor coupled to the first compression mechanism and the expansion mechanism by a shaft, and a first closed casing accommodating the first compression mechanism, the expansion mechanism and the first motor;
a second compressor including a second compression mechanism for compressing the refrigerant connected in parallel with the first compression mechanism in a refrigerant circuit, a second motor coupled to the second compression mechanism by a shaft, and a second closed casing accommodating the second compression mechanism and the second motor;
a radiator for radiating heat from the refrigerant discharged from the first compression mechanism and the second compression mechanism;
a first pipe connecting the first compression mechanism and the second compression mechanism to the radiator;
a second pipe connecting the radiator to the expansion mechanism;
an injection passage, branched from the second pipe, for supplying additionally the refrigerant to the expansion mechanism during an expansion process;
an opening-adjustable injection valve provided in the injection passage; and
a controller for performing an optimizing operation for the opening of the injection valve by controlling rotation speeds of the first motor and the second motor as well as the opening of the injection valve so as to bring the opening of the injection valve closer to a fully closed state or closer to a fully opened state while keeping a pressure or a temperature of the discharged refrigerant guided to the radiator through the first pipe approximately constant.

2. The refrigeration cycle apparatus according to claim 1, wherein when performing the optimizing operation for the opening of the injection valve, the controller decides whether the opening of the injection valve should be brought closer to the fully closed state or closer to the fully opened state, and if the controller decides that the opening should be brought closer to the fully closed state, the controller decreases the opening of the injection valve while increasing the rotation speed of the first motor and decreasing the rotation speed of the second motor, and if the controller decides that the opening should be brought closer to the fully opened state, the controller increases the opening of the injection valve while decreasing the rotation speed of the first motor and increasing the rotation speed of the second motor.

3. The refrigeration cycle apparatus according to claim 2, wherein the controller repeats an adjustment process in which the rotation speeds of the first motor and the second motor each are changed only by a specified amount and then the opening of the injection valve is changed so as to bring the pressure or the temperature of the discharged refrigerant closer to a target value until the pressure or the temperature of the discharged refrigerant fails to reach the target value, and when the pressure or the temperature of the discharged refrigerant fails to reach the target value, the controller returns the rotation speeds of the first motor and the second motor as well as the opening of the injection valve to a condition one time earlier.

4. The refrigeration cycle apparatus according to claim 2, wherein when performing the optimizing operation for the opening of the injection valve, the controller detects a current opening of the injection valve and acquires a reference opening defined in advance, and if the current opening is lower than the reference opening, the controller decides that the opening of the injection valve should be brought closer to the fully closed state, and if the current opening is higher than the reference opening, the controller decides that the opening of the injection valve should be brought closer to the fully opened state.

5. The refrigeration cycle apparatus according to claim 2, wherein when performing the optimizing operation for the opening of the injection valve, the controller judges whether a total value of a power consumption of the first motor and that of the second motor is decreased or increased when the controller decreases the rotation speed of the first motor only by a specified amount and increases the rotation speed of the second motor only by the specified amount, and increases the opening of the injection valve so that the pressure or the temperature of the discharged refrigerant reaches the target value, and if the total value is decreased, the controller decides that the opening of the injection valve should be brought closer to the fully opened state, and if the total value is increased, the controller decides that the opening of the injection valve should be brought closer to the fully closed state.

6. The refrigeration cycle apparatus according to claim 2, wherein when performing the optimizing operation for the opening of the injection valve, the controller judges whether a total value of a power consumption of the first motor and that of the second motor is decreased or increased when the controller increases the rotation speed of the first motor only by a specified amount and decreases the rotation speed of the second motor only by the specified amount, and decreases the opening of the injection valve so that the pressure or the temperature of the discharged refrigerant reaches the target value, and if the total value is decreased, the controller decides that the opening of the injection valve should be brought closer to the fully closed state, and if the total value is increased, the controller decides that the opening of the injection valve should be brought closer to the fully opened state.

7. The refrigeration cycle apparatus according to claim 2, wherein when performing the optimizing operation for the opening of the injection valve, the controller judges whether a total value of a value of a current flowing through the first motor and a value of a current flowing through the second motor is decreased or increased when the controller decreases the rotation speed of the first motor only by a specified amount and increases the rotation speed of the second motor only by the specified amount, and increases the opening of the injection valve so that the pressure or the temperature of the discharged refrigerant reaches the target value, and if the total value is decreased, the controller decides that the opening of the injection valve should be brought closer to the fully opened state, and if the total value is increased, the controller decides that the opening of the injection valve should be brought closer to the fully closed state.

8. The refrigeration cycle apparatus according to claim 2, wherein when performing the injection valve opening optimizing operation, the controller calculates a saturated injection pressure from a pressure and a temperature of the refrigerant flowing through the second pipe and detects a valve downstream pressure on a downstream side of the injection valve in the injection passage, and if the valve downstream pressure is lower than the saturated injection pressure, the controller decides that the opening of the injection valve should be brought closer to the fully closed state, and if the valve downstream pressure is higher than the saturated injection pressure, the controller decides that the opening of the injection valve should be brought closer to the fully opened state.

9. The refrigeration cycle apparatus according to claim 1, wherein the controller increases the rotation speeds of the first motor and the second motor to the same rotation speed as each other corresponding to an outside air temperature upon starting, and then performs the optimizing operation for the opening of the injection valve.

10. The refrigeration cycle apparatus according to claim 1, wherein the controller increases the rotation speeds of the first motor and the second motor to different rotation speeds from each other corresponding to an outside air temperature upon starting, and then performs the optimizing operation for the opening of the injection valve.

11. The refrigeration cycle apparatus according to claim 1, wherein the controller ends the optimizing operation for the opening of the injection valve when one of the rotation speeds of the first motor and the second motor is equal to a lower limit value or an upper limit value of an allowable driving range.

12. The refrigeration cycle apparatus according to claim 2, wherein when performing the optimizing operation for the opening of the injection valve, the controller judges whether a total value of a value of a current flowing through the first motor and a value of a current flowing through the second motor is decreased or increased when the controller increases the rotation speed of the first motor only by a specified amount and decreases the rotation speed of the second motor only by the specified amount, and decreases the opening of the injection valve so that the pressure or the temperature of the discharged refrigerant reaches the target value, and if the total value is decreased, the controller decides that the opening of the injection valve should be brought closer to the fully closed state, and if the total value is increased, the controller decides that the opening of the injection valve should be brought closer to the fully opened state.
